(19) United States
(12) Patent Application Publication
(10) Pub. No.: US 2020/0167844 A1
(43) Pub. Date: May 28, 2020

(54) MEMBERSHIP-BASED DIGITAL MUTUAL COOPERATION SYSTEM AND METHOD

(71) Applicants: Byung Ho KIM, Gyeongsangnam-do (KR); Seong Chul LEE, Yongin-si (KR)

(72) Inventors: Byung Ho KIM, Gyeongsangnam-do (KR); Seong Chul LEE, Yongin-si (KR)

(21) Appl. No.: 16/686,298

(22) Filed: Nov. 18, 2019

(30) Foreign Application Priority Data
Nov. 27, 2018 (KR) 10-2018-0148456

(51) Int. Cl. G06Q 30/06

(52) U.S. Cl. CPC G06Q 30/0613; G06Q 30/0633; G06Q 30/0641

(57) ABSTRACT

The present invention is directed to a membership-based digital mutual cooperation system and method in which the members of a mutual cooperation group are organized based on a network membership system in which the numbers of provisions of maintenance benefits and recommendation benefits are limited, business profits are generated by mediating products or services that members want to purchase via a joint purchase method, and the generated business profits are distributed to the members of the network membership system in a virtuous-circle fashion. In the membership-based digital mutual cooperation system and method according to the present invention, virtuous-circle relationships are established among all members including a first seller, intermediate sellers, and consumers.

### CROSS-REFERENCE TO RELATED APPLICATION

This application claims the benefit of Korean Patent Application No. 10-2018-0148456 filed on Nov. 27, 2018, which is hereby incorporated by reference herein in its entirety.

### BACKGROUND

### 1. Technical Field

The present invention relates generally to a membership-based digital mutual cooperation system and method, and more specifically to a membership-based digital mutual cooperation system and method in which the members of a mutual cooperation group are organized based on a network membership system in which the numbers of provisions of maintenance benefits and recommendation benefits are limited, business profits are generated by mediating products or services that members want to purchase via a joint purchase method, and the generated business profits are distributed to the members of the network membership system in a virtuous-circle fashion.

### 2. Description of the Related Art

In Korea, there have been traditional ways of dividing or sharing difficulty regarding products or services in order to pursue all the interests of individuals and a group in the form of Dure, Pumasi, Gye, etc. However, in modern times, as traditional village-level organizations or large families have been dismantled, traditional cultures such as Dure, Pumasi, etc. have been disappearing due to temporal and spatial limitations. In today's society, the Korean traditional Dure, Pumasi, Gye, etc. could be activated more and more because people's thoughts can be conveyed in real time via various tools of communication beyond temporal and spatial limitations. However, they are rather disappearing.

In today's society, the development of mass media such as broadcasting or the Internet enables consumers to easily access information on various products such as home appliances, communication devices, foodstuffs, clothing, real estates, health products, etc., and thus consumers can choose and purchase products or services suitable for them.

Meanwhile, methods of selling products to consumers include: an existing market method of displaying products so that consumers can directly select products; a door-to-door sales method of carrying products, visiting consumers, and promoting and selling the produces to the consumers; a mail-order sales method of advertising information about products through an advertising media means, receiving orders directly from consumers through mail and a communication means, and then selling the products; and a multilevel sales method in which sellers of various levels receive products from a product provider who supplies the products and sell the products directly to consumers and the sellers are connected through vertical relationships in order to connect the product provider and the consumers.

Among these product sales methods, the conventional multilevel sales method is performed to sell products through a product distribution process in which products are transferred from a product provider through multilevel intermediate sellers to a final consumer. In this method, when a product is transferred from the product provider to a consumer, it may be sold from the product provider directly to a consumer or may be sold through an intermediate seller.

In the above method of selling products through multiple steps, the intermediate seller directly connects and sells between the product provider and the consumer, and thus costs for promotion via an advertising means and the securement of a sales place for the display of products, with the result that products can be distributed with even a small amount of capital.

Furthermore, the intermediate sellers of the multiple steps are organized such that the intermediate sellers of lower steps subordinate to the intermediate sellers of higher steps are organized in a multilevel structure for the purpose of the efficient promotion and sales of products. Therefore, the intermediate sellers of higher steps have larger numbers of intermediate sellers. In this manner, the sales profits generated when products are sold to consumers are distributed between the product provider and the intermediate sellers of multiple steps at predetermined ratios. Higher steps have larger numbers of lower-step intermediate sellers, and thus sales activities are actively performed, thereby allowing higher profits to be expected.

The related art concerning the Korean traditional organization culture, such as Dure, Pumasi, Gye, etc., and multilevel sales methods includes the following technologies. Korean Patent Application Publication No. 10-2007-0096313 discloses an electronic commerce system and method using a personal connections-based Pumasi method, in which a shopping mall and a web community are linked to each other online based on Korean traditional customs, and thus a member can purchase a desired product through the collection of a purchasing price that is performed in such a manner that a large number of other members can freely deposit parts of the purchasing price of the sales product of the shopping mall registered on the member's personal website according to their personal circumstances. Korean Patent Application Publication No. 10-2003-0088403 discloses a multilevel electronic commerce method, including: receiving a first identification code already allocated to a specific product from a potential purchaser; allowing a second identification code to be allocated to the purchaser at the same time that the product is purchased; setting network tree coordinates so that the second identification code is subordinate to the first identification code, and registering the tree coordinates; determining whether or not a sales termination point for the product has been reached; selecting at least one identification code among the lowest identification codes of the network tree for the product when the sales termination point has been reached; and registering the selected identification code as a priority sales code having a right to preferentially purchase a product to be sold continuously. Korean Patent Application Publication No. 10-2015-0046827 discloses a server and method for the distribution of profits of multilevel commerce, the method including: classifying and storing members subscribed as intermediate sellers in a multi-level commerce according to their level; extracting lower-level sellers below a predetermined level from members; detecting lower-level sellers, who satisfy a first predetermined condition during a predetermined period, from the extracted lower-level sellers; and assigning some or all of the profits resulting from multilevel commerce to the detected lower-level sellers.

However, in the conventional multilevel sales method disclosed in the related art, a problem arises in that conventional profit distribution is advantageous to higher-step intermediate sellers, and thus lower-step sellers may always be excluded from higher-profit beneficiaries or rather victimized.

### SUMMARY

The present invention has been conceived to overcome the above-described problems and to supplement the related art, and an object of the present invention is to provide a membership-based digital mutual cooperation system and method in which a digital mutual cooperation system is constructed such that organized and complex sales and profit distribution can be performed through various channels of the wired and wireless Internet and offline sales, which are the basis of electronic commerce, i.e., online sales, and is designed to be modeled after the Korean traditional method “Dure” and distribute sales profits equally and fairly to all registered members in order to achieve continuous and successive online and offline commerce promotion effects.

In order to accomplish the above object, the present invention provides a membership-based digital mutual cooperation system including: members who each set up a one-person business; a manufacturer which registers himself or herself with the members over a wired or wireless connection and supplies products or services to the member; and a server including a member management unit which collects, arranges and manages member information or manufacturer information entered by the members and the manufacturer, a joint purchase management unit which collects, arranges and manages the details of a joint purchase when some of the members each attempting to set up a one-person business make a joint purchase of products or services from the manufacturer, a settlement management unit which differentially distributes generated profits according to the contribution levels of the members and the manufacturer based on the data of the joint purchase management unit in the form of products or services, and a control unit which mediates among the member management unit, the joint purchase management unit, and the settlement management unit and performs control so that a collision does not occur.

The members, the manufacturer, and the control unit, the member management unit, the joint purchase management unit and the settlement management unit constituting the server perform wired or wireless communication over an online or offline connection online or offline.

In other words, the members and the manufacturer each include a terminal. The terminal may communicate with the server via online communication. The members and the manufacturer each communicate using a face-to-face method offline.

Each of the members may be one person, one branch, or one base. In the structure of the members, a first founder makes a joint purchase of products or services from the manufacturer, and sells the products or services to a second founder, thereby generating business profits. When the first founder registers the second founder and then registers another founder, the other founder is registered at step S3, which is a step immediately below the second founder other than step S2, which is a step corresponding to the second founder. Furthermore, when the first founder registers still another founder, the still another founder is registered at step S4, which is a step immediately below a third founder, other than step S3, which is a step corresponding to the third founder. In the same manner, when the first founder registers still another founder, this still another founder becomes a fifth founder corresponding to step S5.

In the structure of the members, one branch is established with one branch manager assigned per a population of 10,000, and one base is established with one base manager assigned per a population of 100,000.

As described above, all the members registered by the first founder based on promotion, recommendation, business activities, and/or the like are registered at steps lower than the step corresponding to the first founder. In other words, when some of the members make a joint purchase from the manufacturer, related information is stored and managed by the joint purchase management unit of the server, and generated profits are distributed to the members of higher steps by the settlement management unit in the form of products or services.

In other words, when the fifth founder corresponding to step S5 purchases products or services from the manufacturer through a joint purchase and sells the products or services to the member of a lower step, related information is stored in the joint purchase management unit of the server, and generated business profits are distributed to the fourth founder of step S4, which is a higher step, the third founder of a higher step, the second founder of a higher step, and the first founder of a higher step based on predetermined benefits by the settlement management unit.

As described above, the first founder may register the second founder, third founder, fourth founder, and fifth founder of his or her own lower steps.

Furthermore, the second founder may also register the founder of step S3, the founder of step S4, and the founder of step S5 corresponding to his or her own lower steps. In the same manner, the third founder may also register the founder of step S4 and the founder of step S5 corresponding to his or her own lower steps.

As described above, all the members may be founders. Although the steps of the members are determined by the first founder, a first founder may be made out of each of the members by a member registered at his or her own lower step.

Each of the members needs to register only one lower-step member like the first founder. If one of the members wants to have his or her own lower step, he or she can register a new lower-step member by promotion, business activities, and/or the like, thereby building his or her own lower step.

A membership-based digital mutual cooperation method according to the present invention includes: a member registration step of registering members, for example, in such a manner that a first founder registers a second founder, the second founder registers the founder of step S3, and the first founder registers the third founder, and also registering a manufacturer which sells products or services to the members; a member data storage and arrangement step of safely storing and sequentially arranging data received from the registered members and the manufacturer by using the member management unit; a members' joint purchase and manufacturer's sale step of making a joint purchase of or selling products or services, to be sold to a lower-step member, between some registered members and the manufacturer; a business profit management step of registering the business profits generated when the products or services purchased at the members' joint purchase and manufacturer's sale step are sold to a lower-step member and the business profits of the manufacturer generated when the members purchase the products or services from the manufacturer through a joint purchase with the joint purchase management unit of the server and managing the business profits; and a differential distribution and settlement step of distributing the generated business profits in accordance with the steps of the members and also distributing the generated business profits, distributed, provided and settled in accordance with the bonus points of the manufacturer, according to the contribution levels of the members.

As described above, in the membership-based digital mutual cooperation system and method according to the present invention, any member may have a lower-step member, so that all the members may make a joint purchase from the manufacturer and anyone may maintain step S1, which corresponds to the first founder. Therefore, there may be overcome the problem of the related prior in which conventional profit distribution is advantageous to higher-step intermediate sellers, and thus lower-step sellers may always be excluded from higher-profit beneficiaries or rather victimized.

In this way, a membership system, such as the Korean traditional mutual cooperation method “Dure,” is constructed, the members, the manufacturer and the server are organized over an online or offline connection, the member and another member communicate with each other, and the members and the manufacturer communicate with one another via a wired or wireless communication method or a face-to-face method, thereby pursuing mutual benefits.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram showing the configuration of a membership-based digital mutual cooperation system;

FIG. 2 is a diagram showing the structure of the members of a membership-based digital mutual cooperation system and method; and

FIG. 3 is a flowchart of a membership-based digital mutual cooperation method.

### DETAILED DESCRIPTION

The present invention will be described in detail below through the accompanying drawings and embodiments. In the following description of the present invention, when it is determined that a detailed description of a well-known function or configuration related to the present invention may unnecessarily make the gist of the present invention obscure, the detailed description will be omitted.

Furthermore, the terms that will be described later are terms that are defined by taking into consideration their functions in the present invention, and may vary depending on a user, the intention of an operator, or practice. Therefore, the definitions of the terms should be made based on the context of the overall present specification.

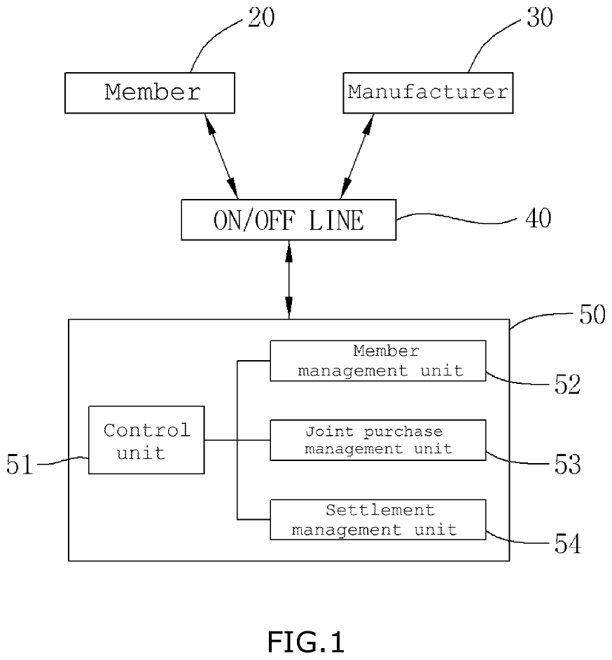

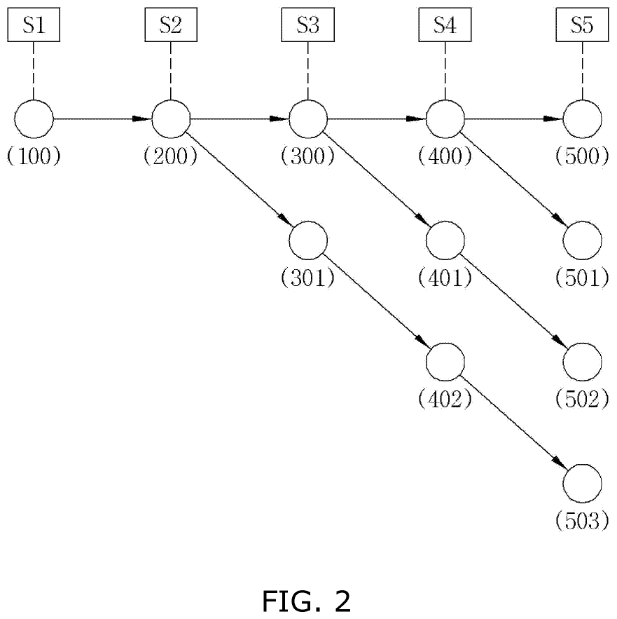

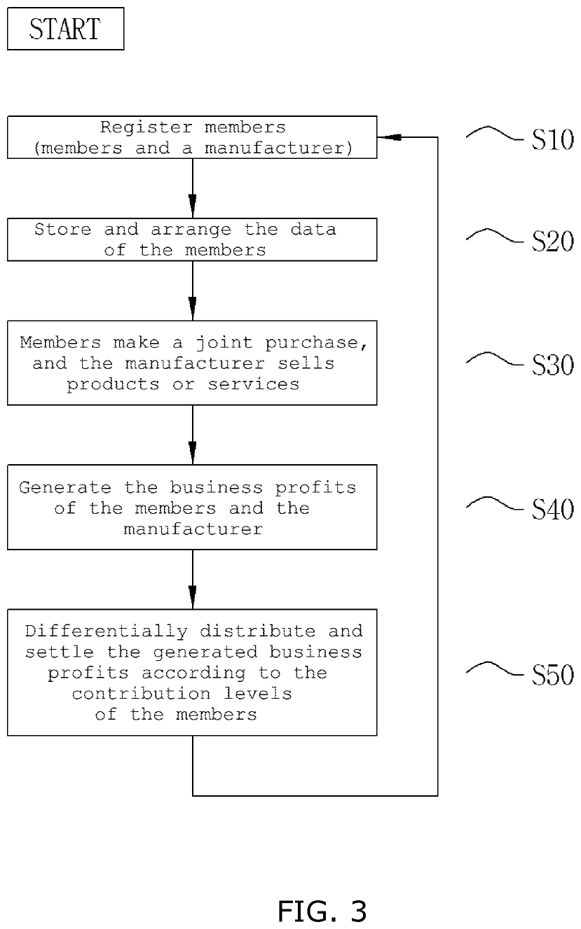

FIG. 1 is a diagram showing the configuration of a membership-based digital mutual cooperation system, FIG. 2 is a diagram showing the structure of the members of a membership-based digital mutual cooperation system and method, and FIG. 3 is a flowchart of a membership-based digital mutual cooperation method.

A detailed description will be given with reference to FIGS. 1 and 2. Members 20 may each be one free person. Furthermore, each of the members 20 may be one branch or one base. The one branch may have one branch manager per a population of 10,000, and the one base may have one base manager per a population of 100,000.

The membership-based digital mutual cooperation system includes: members 201 who each set up a one-person business; a manufacturer 30 which registers himself or herself with the members 20 over a wired or wireless connection and supplies products or services to the members 201; and a server 50 including a member management unit 52 which collects, arranges and manages member information or manufacturer information entered by the members 20 and the manufacturer 30, a joint purchase management unit 53 which collects, arranges and manages the details of a joint purchase when some of the members 20 each attempting to set up a one-person business makes a joint purchase of products or services from the manufacturer 30, a settlement management unit 54 which differentially distributes generated profits according to the contribution levels of the members 20 and the manufacturer 30 based on the data of the joint purchase management unit 53 in the form of products or services, and a control unit 51 which mediates among the member management unit 52, the joint purchase management unit 53, and the settlement management unit 54 and performs control so that a collision does not occur.

The members 20, the manufacturer 30 and the server 50 perform wired or wireless communication over an online or offline connection 40 online or offline. The members 20 and the manufacturer 30 each include a terminal. The terminal may communicate with the server 50 via online communication. The members 20 and the manufacturer 30 each communicate offline by using a face-to-face method.

Each of the members 20 may be one person, one branch, or one base. In the structure of the member 20, a first founder 100 makes a joint purchase of products or services from the manufacturer 30, and sells the products or services to a second founder 200, thereby generating business profits. When the first founder 100 registers the second founder 200 and then registers another founder, the other founder is registered at step S3, which is a step immediately below the second founder 200 other than step S2, which is a step corresponding to the second founder 200. Furthermore, when the first founder 100 registers still another founder, the still another founder is registered at step S4, which is a step immediately below a third founder 300, other than step S3, which is a step corresponding to the third founder 300. In the same manner, when the first founder 100 registers still another founder, this still another founder becomes a fifth founder 500 corresponding to step S5.

As described above, each of the members 20 may set up a one-person business as a free person. One branch is established with one branch manager assigned per a population of 10,000, and one base is established with one base manager assigned per a population of 100,000.

As described above, all the members 20 registered by the first founder 100 based on promotion, recommendation, business activities, and/or the like are registered at steps lower than the step corresponding to the first founder 100. In other words, when the members 20 make a joint purchase from the manufacturer 30, related information is stored and managed by the joint purchase management unit 53 of the server 50, and profits are distributed to the members 20 of higher steps by the settlement management unit 54 in the form of products or services.

In other words, when the fifth founder 500 corresponding to step S5 purchases products or services from the manufacturer 30 through a joint purchase and sells the products or services to the member 20 of a lower step, related information is stored in the joint purchase management unit 53 of the server 54, and generated business profits are distributed to the fourth founder 400 of step S4, which is a higher step, the third founder 300 of a higher step, the second founder 200 of a higher step, and the first founder 100 of a higher step based on predetermined benefits by the settlement management unit 54.

As described above, the first founder 100 may register the second founder 200, third founder 300, fourth founder 400, and fifth founder 500 of his or her own lower steps, and the second founder 200 may also register the founder 301 of step S3, the founder 402 of step S4, and the founder 503 of step S5 corresponding to his or her own lower steps. In the same manner, the third founder 300 may also register the founder 401 of step S4 and the founder 502 of step S5 corresponding to his or her own lower steps.

As described above, all the members 20 may be founders. Although the steps of the members 20 are determined by the first founder 100, a first founder 100 may be made out of each of the members 20 by a member 20 registered at his or her own lower step. Each of the members 20 needs to register only one lower-step member 20 like the first founder 100. If one of the members 20 wants to have his or her own lower step, he or she can register a new lower-step member 20 by promotion, business activities, and/or the like, thereby building his or her own lower step.

The following detailed description will be given with reference to FIG. 3.

The membership-based digital mutual cooperation method includes: a member registration step S10 of registering the members 20, for example, in such a manner that the first founder 100 of FIG. 2 registers the second founder 200, the second founder 200 registers the founder 301 of step S3, and the first founder 100 registers the third founder 300, and also registering the manufacturer 30 which sells products or services to the members 20; a member data storage and arrangement step S20 of safely storing and sequentially arranging data received from the registered members 20 and the manufacturer 30 by using the member management unit 52; a members' joint purchase and manufacturer's sale step S30 of making a joint purchase of or selling products or services to be sold to a lower-step member 20 between some registered members 20 and the manufacturer 30; a business profit management step S40 of registering the business profits generated when the products or services purchased at the members' joint purchase and manufacturer's sale step S30 are sold to a lower-step member 20 and the business profits of the manufacturer 30 generated when the members 20 purchase the products or services from the manufacturer 30 through a joint purchase with the joint purchase management unit 53 of the server 50 and managing the business profits; and a differential distribution and settlement step S50 of distributing the generated business profits in accordance with the steps of the members 20 and also distributing the generated business profits, distributed, provided and settled in accordance with the bonus points of the manufacturer 30, according to the contribution levels of the members.

At the member registration step S10, when each of the members 20 of FIG. 1 sets up a one-person business as a free person, establishes one branch with one branch manager assigned per a population of 10,000, or establishes one base with one base manager assigned per a population of 100,000 and then registers with the server 50, the data of the member 20 is stored and managed via the member management unit 52 of the server 50. Furthermore, when the manufacturer 30 registers with the server 50 in the same manner as the member 20 in order to supply products or services to the member 20, the data of the manufacturer 30 is stored and managed via the member management unit 52 of the server 50.

At the member data storage and arrangement step S20, the first founder 100 corresponding to step S1 of FIG. 2, the second founder 200 of step S2, which is a lower step, the third founder 300 of step S3, the fourth founder 400 of step S4, and the fifth founder 500 of step S5 are arranged in descending order, and still another founder 301 of step S3 is located at the same level as the third founder 300 of step S3. In the same manner, the founders 401, 402, 501, 502, and 503 of steps S4 and S5 are located, stored and arranged at appropriate levels.

If one of the members wants to have his or her own lower step like the first founder 100, he or she can continue to make a new lower-step member subscribe through promotion, business activities, and/or the like. When the member 20 makes only one member 20 subscribe, purchases products or services from the manufacturer 30 and sells the products or services to the subscribed member 20, this structure is included in the digital mutual cooperation system according to the present invention, and the number of lower-step members 20 will increase.

Therefore, the present invention enables each of the members to increase the number of lower-step members 20 based on his or her ability, unlike the related art. Even when the member does not have sufficient ability, it is sufficient if he or she subscribes only one member 20, and thus the present invention overcomes the problems of the related art.

At the members' joint purchase and manufacturer's sale step S30, the manufacturer 30 may register products or services for sale, including their prices, with the server 50, and some of the members 20 may purchase the registered products or services at inexpensive prices through a joint purchase, and may sell the registered products or services to a lower class member 20 in an intermediate manner.

At the business profit management step S40, business profits are generated when the members 20 sell the products or services, purchased from the manufacturer 30 through a joint purchase, to a lower-step member 20 in an intermediate manner. Since products or services are purchased from the manufacturer 30 in the form of a joint purchase, a variety of manufacturers supply products or services through competitions, and thus the products or services are supplied to the members 20 at cheaper prices. The members 20 who purchase the products or services through the above process may obtain business profits by selling the products or services to a lower-step member 20, and the manufacturer 30 may accumulate bonus points in proportion to selling prices and settle the bonus points in the future.

At the differential distribution and settlement step S50 of distributing the generated business profits in accordance with the contribution levels of the members 20, the business profits generated by selling products or services at the business profit management step S40 are differentially distributed such that as the step increases, the distributed benefits decrease.

For example, the business profits generated when the fifth founder 500, who is the member 20 of step S5 of FIG. 2, sells products or services to a lower-step member 20 are differentially distributed such that as the step increases, the distributed benefits decrease, in such a manner that 10% of the business profits is provided to the fifth founder 500, who is the seller himself or herself, 9% of the business profits is provided to the fourth founder 400, who corresponds to a higher step, 8% of the business profits is provided to the third founder 300, who corresponds to a higher step, 7% of the business profits is provided to the second founder 200, who corresponds to a higher step, and 6% of the business profits is provided to the first founder 100, who corresponds to a higher step.

Through the membership-based digital mutual cooperation system and method according to the present invention, there may be overcome the problem of the related prior in which conventional profit distribution is advantageous to higher-step intermediate sellers, and thus lower-step sellers may always be excluded from higher-profit beneficiaries or rather victimized.

Furthermore, the manufacturer 30 may register itself through a fair competition via the server 50 at step S10, may set prices for products or services to be supplied, and may notify the server 50 of the prices. When the member 20 purchases the products or services of the corresponding manufacturer 30 after viewing the prices, bonus points are provided in proportion to the purchasing cost, and the bonus points thus provided may be settled as benefits later.

As described above, in the membership-based digital mutual cooperation system and method according to the present invention, any member 20 may have a lower-step member 20, so that all the members 20 may make a joint purchase from the manufacturer 30 and anyone may maintain step S1, which corresponds to the first founder 100. Therefore, there may be overcome the problem of the related prior in which conventional profit distribution is advantageous to higher-step intermediate sellers, and thus lower-step sellers may always be excluded from higher-profit beneficiaries or rather victimized.

In the membership-based digital mutual cooperation system and method according to the present invention, virtuous-circle relationships are established among all members including a first seller, intermediate sellers, and consumers, so that an advantage arises in that the benefits of promoting transactions can be continuously provided not only to an on-line or off-line commerce operator but also to a first seller, intermediate sellers and consumers and also an advantage arises in that the burden of fees can be lowered and the distribution of profits fairly provided to all members can be increased, so that the distribution of profits can be additionally performed because there is no cost for the promotion of products or services and the securing of a sales place.

The embodiments described above are merely examples, and the present invention is not limited to the embodiments. Anything that has substantially the same configuration and achieves the same effect as the technical spirit described in the appended claims falls within the technical scope of the present invention.

What is claimed is:

1. A membership-based digital mutual cooperation method comprising:
a member registration step of registering members and also registering a manufacturer which sells products or services to the members, wherein the member registration step is performed, for example, in such a manner that a first founder registers a second founder, registers yet another founder at a third step, which is a step immediately lower than the second founder, other than a second step, which is a step of the second founder, registers still another founder at a fourth step, which is a step immediately lower than the third founder, other than a third step, which is a step of the third founder, and registers still another founder as a fifth founder at a fifth step;
a member data storage and arrangement step of safely storing and sequentially arranging data received from the registered members and the manufacturer by using the member management unit;
a members' joint purchase and manufacturer's sale step of making a joint purchase of or selling products or services, to be sold to a lower-step member, between some registered members and the manufacturer;
a business profit management step of registering the business profits, generated when the products or services purchased at the members' joint purchase and manufacturer's sale step are sold to a lower-step member, and the business profits of the manufacturer, generated when the members purchase the products or services from the manufacturer through a joint purchase with the joint purchase management unit of the server, and managing the business profits; and
a differential distribution and settlement step of distributing the generated business profits in accordance with steps of the members and also distributing the generated business profits, distributed, provided and settled in accordance with bonus points of the manufacturer, according to contribution levels of the members;
wherein the members and the manufacturer each comprise a terminal, the terminal communicates with a server via online communication, the members and the manufacturer communicate using a face-to-face method offline, and each of the members is one person, one branch having one branch manager per a population of 10,000, or one base having one base manager per a population of 100,000.

2. The membership-based digital mutual cooperation method of claim 1, wherein at the members' joint purchase and manufacturer's sale step, the manufacturer registers the products or services, determines prices of the products or services, and provides notification of the prices of the products or services, and wherein the business profits generated at the business profit management step are differentially provided according to levels of the members.
